(19) United States
(12) Patent Application Publication
(10) Pub. No.: US 2011/0019725 A1
(43) Pub. Date: Jan. 27, 2011

(54) DSL METHOD HAVING VARIABLE UPLOAD/DOWNLOAD BIT RATE AND APPLICATION-SPECIFIC DYNAMIC PROFILE SWITCHING

(76) Inventor: Walter Keller, Ratingen (DE)

Correspondence Address: Law Offices of Robert F. Zielinski, LLC, 1518 Walnut Street, Suite 1706, Philadelphia, PA, 19102, US

(21) Appl. No.: 12/863,550

(22) PCT Filed: Nov. 11, 2008
(86) PCT No.: PCT/EP08/09488

§ 371 Date: Oct. 4, 2010

(30) Foreign Application Priority Data
Jan. 19, 2008 (DE) 10 2008 005 290.6

(51) Int. Cl. H04B 1/38

(52) U.S. Cl. 375/222

(57) ABSTRACT

The present invention relates to a DSL method having preferably DMT frequency bands, which, contrary to the known arrangement having permanently associated upload and download channels, according to the invention comprises universal upload/download frequency channels UUDS (Universal Upload Download Channel) for the optional usage in each traffic direction. The selection and use of the channels for a traffic direction is carried out dynamically during the operation and preferably automatically according to the respectively pending transmission load with application-specific bandwidth adaptation, for example for download and upload applications, voice transmission, video conference, IP-TV and so forth. A particularly advantageous variant (DLC-ADSL, Dynamic Reverse Profile ADSL) is based on the known ADSL standardization with HDP profile (High Download Profile; fast download, slow upload) and an additional inverse profile with switched traffic direction of the transmission channels HUP (High Upload Profile; fast upload, slow download), wherein a switch can be easily carried out between them with a simple command sequence. A symmetrical profile, for example voice, image telephone, peer-to-peer computer coupling and the like, can be a further useful addition.

This invention relates to a method for adaptation of upload and download data transmission rates of a DSL link within, between and/or subsequent to telecommunications or data networks, especially between a subscriber-side modem and the remote station of a switching center, data transmission taking place within a frequency range of a certain total bandwidth divided into transmission channels and a first group of transmission channels which are arranged consecutively or randomly being assigned to upload data transmission and another group of transmission channels which are arranged consecutively or randomly being assigned to download data transmission and the sum of the transmission channels of the two groups corresponding to the total number of transmission channels available for data transmission.

For current broadband telecommunications different standardized DSL methods (digital subscriber line) are used which seek to meet the requirements of the user with respect to the data transmission rate. In particular, asymmetrical DSL methods (ADSL) are common and becoming more so, such as for example ADSL, ADSL2plus, ADSL4, VDSL or VDSL2 which enable increasingly higher download rates in the indicated sequence. A drive to higher and higher download bandwidth results from the increasingly broader band applications. Simple Internet pages nowadays are increasingly loaded with multimedia contents, are in color and are provided with many graphics, audio or music, animation, etc. Electronic mail (E-mail) often contains numerous images, video and audio sequences. In addition there are Internet radio and Internet television (IP-TV also HDTV). Digital video on demand (VoD) is likewise under discussion. One broadband application which comprises Internet, radio and television is the so-called Triple Play; this is already available with a 16 Mbit/s VDSL2 connection.

But there are also applications which usefully or compellingly require a high uplink data rate, also called an upload data rate. Examples of this are the servers which can be reached over the Internet at home or in the office, uploading of audio and video sequences or data files to the Internet, sending images, videotelephony, video conferences, IP voice links, the use of storage media on the Internet (network storage applications), sending of extensive electronic mail or communication between PCs (peer-to-peer PtP).

In the commercial domain the replacement of expensive leased lines for symmetrical data transmission (SDSL) for example for computer coupling by an economical DSL connection would be of interest, since here expensive special hardware both on the customer and network operator side could be avoided.

The individual choice of upload and download data transmission rate which is oriented to the application is not possible for DSL products which are currently available on the German market because they also make available a fixed upload speed which is inherent in the DSL method used at a fixed download speed. Thus, for example in the DSL method which is known as “DSL 1000” and which is offered to private users in Germany with a download transmission rate of 1024 kbit/s, only one upload transmission rate of 128 kbit/s is available. In the DSL method known as “DSL 2000” the download transmission rate is 2048 kbit/s, the upload transmission rate is only 192 kbit/s. Even for higher quality products which are offered for private, nonbusiness use the upload transmission rates compared to download transmission rates are only a fraction of less of 10%.

For applications which require a high upload there is currently only the possibility of changing to a higher quality, expensive DSL connection which has a high download channel (DLC) and then also necessarily a higher quality upload channel (uplink channel—ULC). Higher data rates are however generally subject to higher attenuation in the transmissions region, greater interference and associated with the latter, shorter range, and therefore require much more technical effort. This is expressed in the high price of these links; this is therefore especially disadvantageous because the higher quality bandwidth with the higher download transmission data rate is actually unnecessary for many applications.

Furthermore it is disadvantageous that a subscriber on a DSL connection, once dialed, for which both on the subscriber side and also on the switching center side the necessary hardware (DSL modem) must be set up, is fixed at the transmission rates which are made available with the connection. An increase of the download or upload transmission rate, optionally to the detriment of the transmission rate which is the other one at the time, in the case of non-use of the capacity in one connection direction is not possible. For this purpose, a change of the service which has been set up by the Internet service provider (ISP) and generally replacement or adaptation of hardware are necessary since with a higher quality DSL method additional functionalities are also made available which are not supported by modems which are designed for lower quality DSL methods.

For business customers conversely, on the German market products are also offered in which the download/upload data transmission rates are the same at least in the ideal case. For these products symmetrical DSL methods such as SDSL (symmetric single pair DSL), also called HDSL (high data rate DSL), or SHDSL (symmetric high bit rate DSL) are used which however require high technical effort both on the subscriber side and also on the switching center side and are not very common. These methods are therefore associated with considerable costs and can be made available to only a few subscribers, for lack of popularity. The pertinent products on the German market are subject to costs which are roughly ten times higher compared to comparable products with the corresponding download transmission rates and are therefore not economical for private users.

It is therefore the object of the invention to make available a method for DSL telecommunications links which for any existing asymmetrical DSL method can be used while maintaining its bandwidth, coding methods and modulation methods, and compared to its inherent upload data transmission rate makes available a much higher upload data transmission rate at comparatively low costs.

This object is achieved as claimed in the invention by the method with the features of claim 1. Advantageous embodiments of the invention are contained in the dependent claims and are explained in the following description.

Here it is especially advantageous that in the method as claimed in the invention for adapting the upload and download data transmission rate of a DSL connection within, between, and/or subsequent to telecommunications or data networks, especially between a subscriber-side modem and the remote station of a switching center, transmission takes place within a frequency range of a certain total bandwidth, which frequency range is divided into transmission channels, and a first group of transmission channels is assigned to upload data transmission and a second group of transmission channels is assigned to download data transmission and the sum of transmission channels of the two groups corresponds to the total number of transmission channels available for data transmission, the number of transmission channels of the two groups is changed depending on the required upload and/or download data transmission rates while maintaining the total bandwidth.

Thus, versatile channels which can be used alternatively for upload or download are proposed, an increase in the number of upload channels having to an equal reduction of download channels with the corresponding effects on the respective data transmission rates [sic], the total number of available transmission channels not being increased by the selected method.

This enables use of the entire bandwidth of any existing DSL communications link in an application-specific manner alternatively for download or upload purposes. Thus, important added value for DSL links of all types is created and with the use of an existing DSL link an economical solution for the desired high upload data transmission rates is offered to both private and also business users. Another advantage is that expensive symmetrical DSL links and permanent circuit connections can be at least partially substituted. In particular, in the method as claimed in the invention high-rate upload data rates and symmetrical data rates for voice/video conference are enabled without using expensive symmetrical DSL methods, and without increasing the total bandwidth established in the respective DSL method or having to change to a higher quality, more expensive method with possibly problematic availability.

Alternatively, in the method as claimed in the invention the number of transmission channels of the download connection can be increased in a dedicated manner to the detriment of the upload transmission rate especially when the required download data transmission rate of the DSL standard used for the pending task is not sufficient, or the available conventional upload transmission rate is just not necessary.

Alternatively to a controlled increase in the number of transmission channels in one direction of traffic, it can thus also be provided that in the case of a low data transmission underway in one connection direction unused transmission channels are assigned to the corresponding other traffic direction.

It is especially advantageous in the method as claimed in the invention that the transmission channels available for data transmission are not permanently used only unidirectionally compared to the original standard DSL method, but depending on the current transmission demand are used either in the connection direction to the network (upload) or in the connection direction to the subscriber (download), so that there is bidirectional use of all transmission channels which are available for data transmission.

In one preferred embodiment, in the method as claimed in the invention the upload transmission rate can be adapted by exchanging the numbers of transmission channels of the two groups. Thus, for example it can be provided that in one DSL transmission method with n transmission channels provided for download and m transmission channels provided for upload, n being greater than m, a higher upload data transmission rate can be achieved by the transmission channels provided for upload being used for download and the transmission channels provided for the download being used for the upload. This enables a reversed use of existing transmission channels.

Alternatively, adaptation can be done to obtain a symmetrical data transmission rate in which upload and download transmission rates are equal, by assigning essentially the same numbers of transmission channels of the two groups, this also being defined especially as that case in which one group has one transmission channel more than the other, for example as a result of an odd number of available transmission channels, or alternatively the number of transmission channels used for each group in one transmission direction as the product with the data rate present individually within a transmission channel depending on attenuation, enables the same gross data rates for the two transmission directions. This is especially useful in applications such as IP telephony in voice and/or video (video telephony, video conferences) in which the same amount of data can be transmitted in both connection directions.

Preferably the number and arrangement of transmission channels of one transmission direction at a time as a group can be defined as a transmission profile, and adaptation of the upload and download data transmission rate can take place by switching from a first transmission profile to a second transmission profile, etc. A transmission profile can be for example the division of the number of transmission channels which are available for data transmission, which division is inherent in the DSL connection, between the first and second group. This can be for example the basic setting of the DSL connection. Another transmission profile can be the transport direction of the transmission channels which is the reverse of the indicated base setting, and in turn another transmission profile can be a symmetrical division of the transmission channels between the two groups.

Preferably it can be provided that any suitable transmission profiles be defined and stored in the modems, and switching can take place by sending a control sequence. A suitable transmission profile can be selected for example based on certain given priorities and/or method rules.

Preferably channel switching for alternatively the upload/download direction or complete profile switching can take place dynamically in current operation. This has the advantage that the optimum data transmission rate for the current connection direction is always available to the subscriber.

In one advantageous embodiment, adaptation, especially profile switching, can if necessary take place preferably automatically on the subscriber side by the operating software of the modem or the application software of the user or on the network side by the network operator. This has the advantage that the subscriber need not manually intervene in the transmission properties of the DSL connection and delays in making available an increased upload data transmission rate are avoided.

Furthermore, as claimed in the invention the real time behavior and/or data load of the data transmission can be evaluated in both traffic directions and adaptation of the upload data transmission rate, especially profile switching, can be undertaken depending on this evaluation. Here for example the data load in the upload connection direction can be compared to that of the download connection direction and the number of transmission channels of the first group can be increased accordingly when the data load in the upload connection direction is much higher or the real time behavior in the upload connection direction is much worse.

The real time behavior and/or the data load of the data transmission can be evaluated permanently or temporarily. Adaptation of the upload data transmission rate, especially profile switching, can take place immediately and after the increased data load diminishes in the upload connection direction it can be cancelled again. Preferably then the basic setting can be chosen again.

Alternatively or in combination, for adaptation of the upload data transmission rate, which adaptation is dependent on the evaluation of the connection, especially for profile switching, this can also take place when starting and/or ending the application software, the use of the application software and/or a driver. Thus for example starting of an IP-telephone program (application) or making a call (use) within or by means of the IP telephone program can cause switching to the symmetrical transmission profile and after completing the use or application switching back to the original transmission profile can take place.

It is furthermore advantageous if within an initialization phase of the modems the transmission channels are measured in both transmission directions and the transmission parameters are stored in at least one modem. In this way the transmission properties of the available channels can be determined and in the case of a transmission property which is better in one certain transmission direction, the transmission channel for this transmission direction can be used without delay and without re-remeasuring. Preferably the channel-specific attenuation, modulation and/or amplification parameters can be measured as transmission parameters.

The invention is described below using a detailed explanation of the prior art and its differences and advantages relative to the prior art using exemplary embodiments and the attached figures.

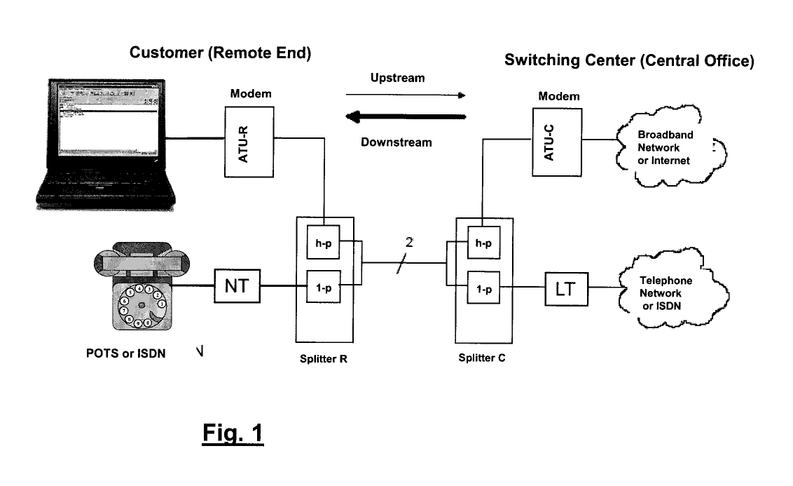

FIG. 1: DSL reference configuration

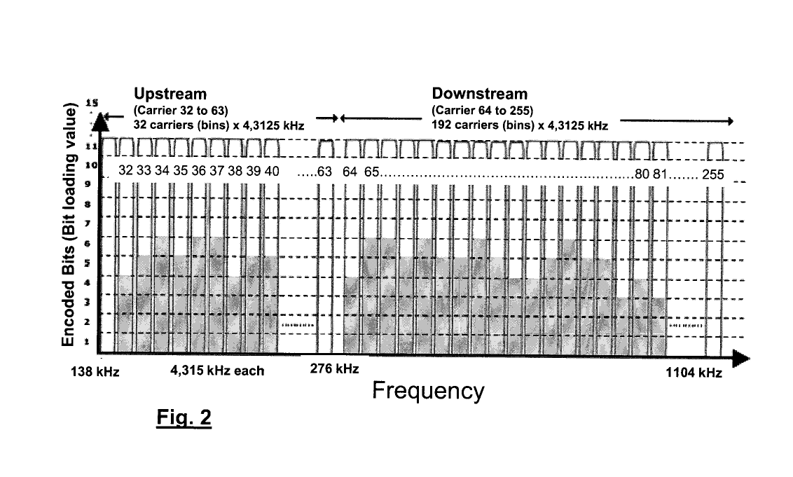

FIG. 2: schematic ADSL-DMT transmission method

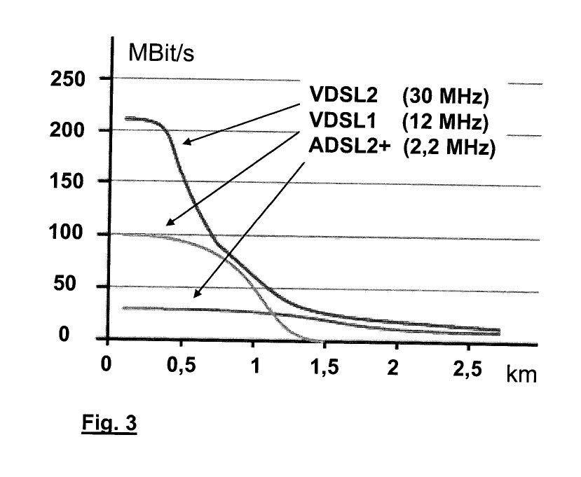

FIG. 3: transmission bandwidth for a different line length

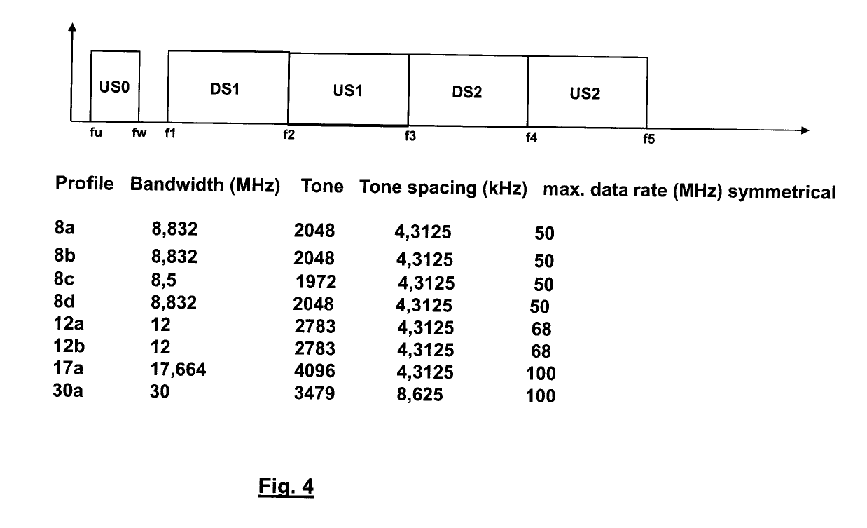

FIG. 4: transmission bands/frequency plan according to ITU-T G.993.2

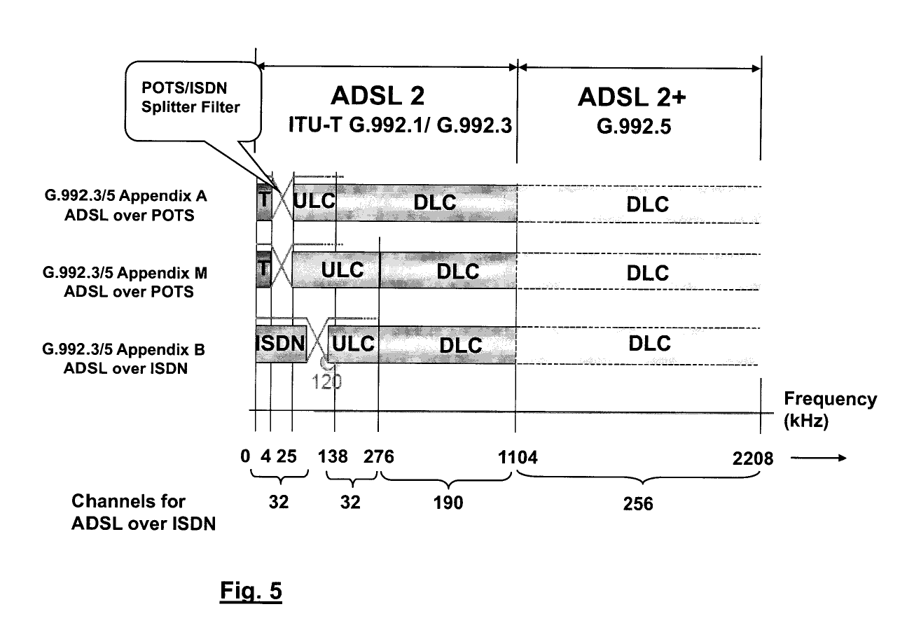

FIG. 5: ADSL2 and ADSL2+ according to ITU-T

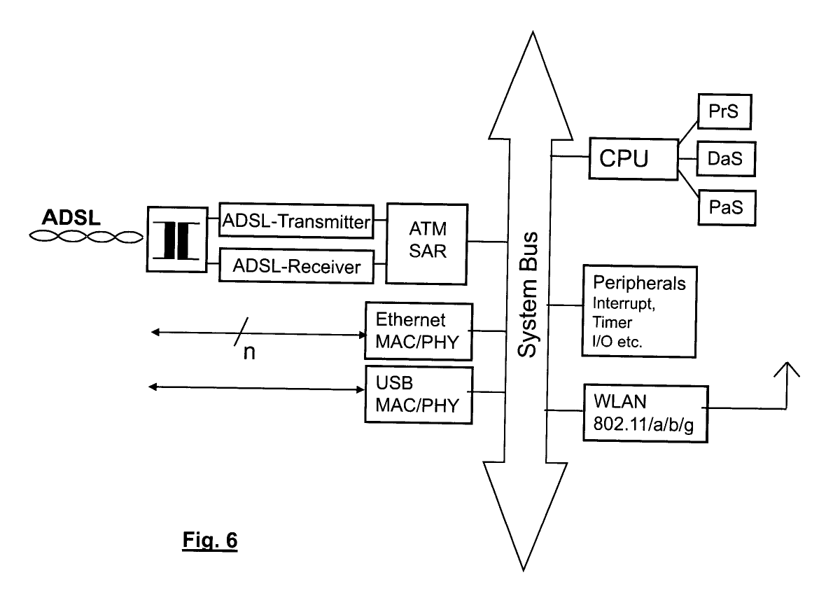

FIG. 6: block diagram ADSL modem with Ethernet router and WLAN connection

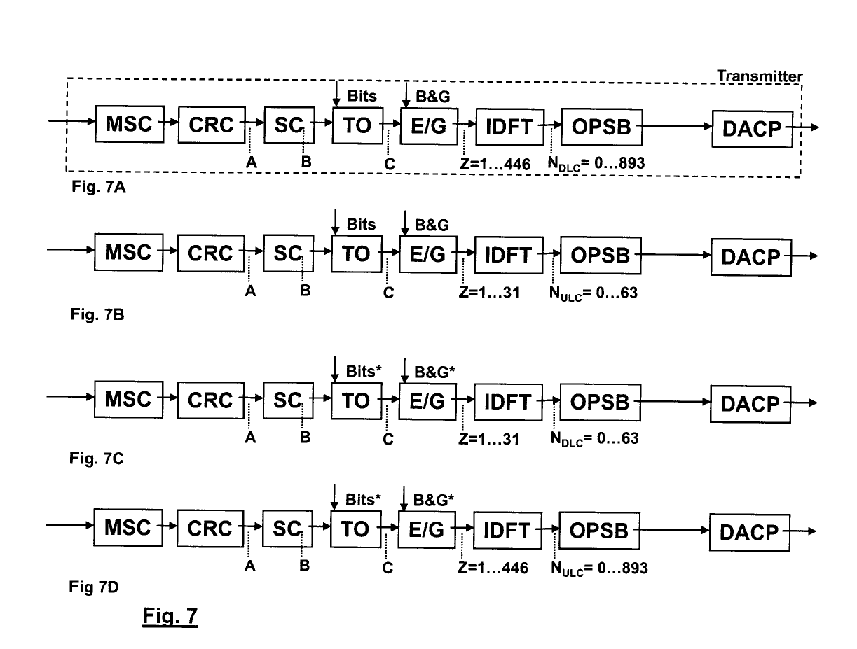

FIG. 7: expanded ADSL transmitter reference configuration

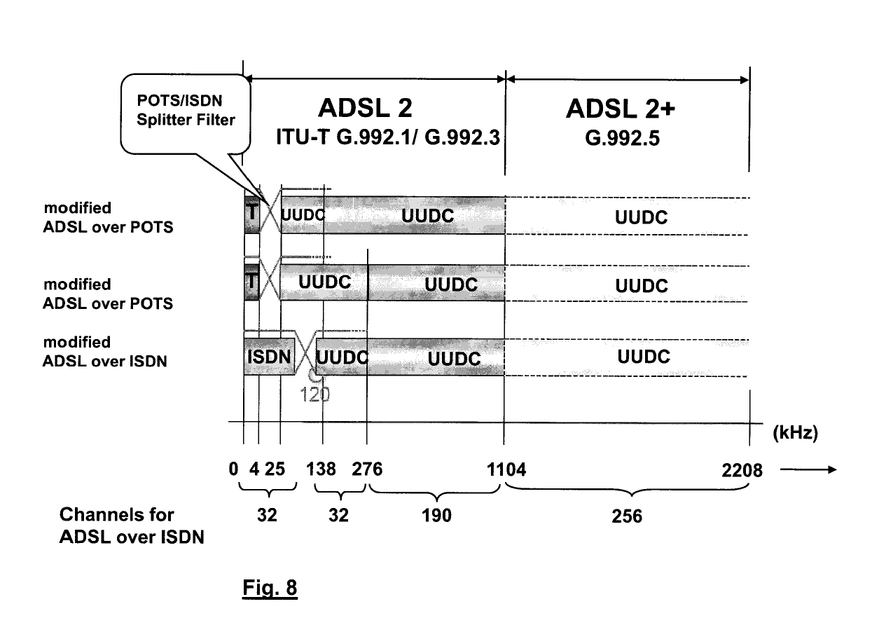

FIG. 8: ADSL2 and ADSL2+ according to ITU-T with use of transmission channels expanded as claimed in the invention.

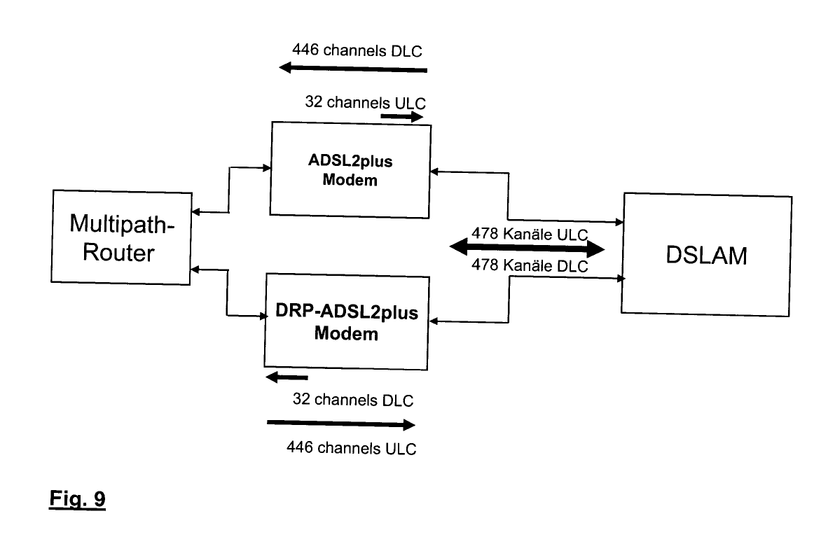

FIG. 9: ADSL technology with high symmetrical data rate.

For a land-line broadband subscriber connection to telecommunications systems and networks, different transmission methods are used which are summarized under the concept of xDSL (digital subscriber line). The letter x is used as a synonym for the different technical implementation versions. The transmission methods share the feature that in this connection the existing cable infrastructure to the customer, the subscriber line, can be used or is to be used. Ultimately this implies the use of copper double wire in paper or plastic insulated cables, which was dimensioned originally for analog transmission of the bandwidth of roughly 300 Hz to 3.4 kHz at a range of a maximum 8 km. This historical telephone service infrastructure is called POS (plain old telephony system). In the course of technical innovation this line has already been used for the ISDN connection (integrated services digital network) of subscriber facilities, on the copper double wire between the switching center and the subscriber line a complex echo compensation method being used and the subscriber line being equipped with a network termination NT on the subscriber side and by means of a line termination LT on the switching center side. In the LT the coupling of 4-wire to 2-wire hardware is done, which is again reversed in the NT. There the so-called So interface with 2×64 kbit/s data channels and a 16 kbit/s signalling channel is made available for the bus connection of several ISDN terminals. The DSL methods take in account in addition to the existing POS and ISDN telephone connections also a high speed IP data channel via the subscriber line which is designed as a synchronous or asynchronous bidirectional data channel with Internet protocol. FIG. 1 schematically shows the connection structure.

In particular, new telecommunications companies like to avoid building telephone switching centers for analog and digital voice channel switching and are increasingly operating their voice service over the IP data channels of the DSL connection (VoIP, Voice over IP). Compared to ISDN this is of less voice quality, largely wastes transmission bandwidth compared to the voice bandwidth of 3.1 kHz and reduces the available data rate for data transmission, but saves infrastructure. New developments take this problem into account and have led to standardization of technologically complex synchronous voice channels within the DSL methods on the physical plane by inserting voice channels in ADSL2, known as CVoDSL (Channelized Voice over DSL) or by high priority protocol elements on the IP plane.

Fundamentally in the DSL domain three different transmission methods are distinguished, specifically symmetrical, asymmetrical and high speed DSL.

In symmetrical DSL methods such as SDSL, also called HDSL (High data rate DSL), or SHDSL (Symmetric High Bit Rate DSL) two double wires are used for separate transmission directions. The best known methods in Europe are the CEPT E1 transmission method (V2m, S2m) with 2.048 MBit/s interface, 2B1Q line code and adaptive line equalization and 32 channel structure with 30 useful channels of 64 kbit each, one synchronization channel and an outband signalling channel for either a D channel protocol (primary multiplex terminal in the subscriber line area) or common channel signalling system CCITT#7 (system coupling in the exchange area) for copper cable (CU) or single-mode glass fiber (GF). In North America there is the less efficient ANSI T1 method with 1.44 Mbit/s, defined in the T1.413 standard of the American National Standards Institute (ANSI) and ITU G.992.1 of the International Telecommunications Union (ITU) with only 24 useful channels of 56 kBit/s each with inband signalling (Onhook/Off-hook). The range is roughly 4.5 km for 0.5 mm copper wire. SDSL systems (Symmetric single pair DSL) have also been suggested which however have not become popular. SDSL requires high technical effort both on the subscriber side and also on the switching center side. Thus the range of the so-called trunk and line card peripherals is roughly 100 m and must be electrically converted in the NL/LT.

For asymmetrical DSL methods (ADSL) the circumstance is exploited that the average Internet user is pursuing highly asymmetrical communications and requires predominantly a high bandwidth for surfing and downloading, i.e. for downloading Internet pages or data onto a personal computer (PC) off the Net, but generally sends only small data volumes or short commands himself, i.e. to the Net, for example in the form of commands or electronic mail. The ADSL method accordingly has great asymmetry between the receiving and sending data. The range is dependent on the respective bandwidth. For example ADSL, ADSL lite, ADSL2, ADSL2+(also called ADSLplus) or ADSL2++ (corresponds to ADSL 4) are used. These methods are detailed below.

In high speed DSL, so-called VDSL (Very High bit Rate DSL) the attainable range is limited to a few hundred meters so that additional hardware such as amplifiers or multiplexers must be located between the switching center Vst and the subscribers. For example, optical fiber optic connections are used between the switching center and the subscriber line area, which terminates in the so-called DSLAM (Digital Subscriber Line Access Multiplexer) and are divided among different existing star-shaped VDSL copper connections of very short range (roughly 150 m) as far as the subscriber. This infrastructure is also called “Fiber to the Curb” (FTTC) since greater distances can only be usefully bridged with a fiber optic infrastructure. In VDSL2 the DSLAM is also called a “VDSL Terminal Unit—Office” (VTU-O). On the subscriber side, i.e. at the customer, there is the VDSL modem. This is also called the “Customer Premises Equipment” (CPE) or “VDSL Terminal Unit—Remote” (VTU-R).

But there are also uses and applications which usefully or urgently necessitate a higher uplink data rate. This is for example the server which can be reached via the Internet in the home domain or in the office (Small Office Home Office, SoHo), uploading of audio and video sequences, sending of pictures, video telephony, videoconferences, IP voice connections, the use of storage media on the Internet, sending of extensive electronic mail, communications between PCs (Peer-to-peer=PtP), etc.

For these uses there is currently only the possibility of switching to a higher quality, expensive DSL connection which has a higher download channel (DLC), then also a higher quality upload channel (uplink channel—ULC). Of course the higher price is disadvantageous especially when the higher quality bandwidth with higher download connection (downlink channel—DLC) is not actually necessary. Higher data rates however require much more technical effort and are generally subject to high attenuation in the transmission domain, greater interference and associated therewith, shorter range. This is expressed in the higher price of these connections.

There is therefore a need for a technical procedure for an economical DSL connection for broadband uploading (high speed upload connection, HS-ULC). This is made available by this invention. It is based on existing DSL methods and meaningfully expands them. With increasing bandwidth the analog modulation method on the subscriber line becomes increasingly more complex. Thus the 2B1Q and 4B3T line codes which are used in ISDN operation for higher transmission rates no longer have enough frequency economy. In current ADSL systems mainly the DMT method (discrete multitone) method is used, the entire frequency domain being divided into individual transmission channels which are each separately coded individually and subject to different transmission parameters are transmitted according to the frequency-specific transmission properties of the cable links. In older methods conversely complete traffic of one direction was encoded (CAP).

The ADSL transmission method is defined in the standard ITU-T G.992.1, due to the deculation method used also called G.DMT and delivers data streams up to 6.144 Mbit/s download and up to 0.640 Mbit/s upload. Historic ADSL transmission according to ANSI standard 71.413-1998 was the so-called CAP (Carrierless Amplitude Phase) method; this is currently only of little importance. The CAP method does not have a comparable multichannel structure as the DMT method. The transmission channel is divided into three frequency domains, the voice band (0-4 kHz), the uplink channel (ULC) (25-160 kHz) and the variable download channel (DLC) with 200 kHz to a maximum 1.1 MHz. The method thus does not have the transmission quality such as the much more flexible DMT method.

Common to all DMT-ADSL methods is the procedure that the upper frequency domain cannot be guaranteed due to different line parameters. The download transmission rate is therefore numbered with a maximum possible value which cannot be achieved in each case.

DMT is a combination of amplitude and phase modulation. In the ITU-T G.992.1 standard the available frequency spectrum is divided into 255 identical component bands, so-called subchannels, also called “bins”, with 4.3125 kHz bandwidth each, which can be modulated and encoded independently of one another and can be subject to different levels. Here the respective middle frequencies are computed from the relation N=n 4.3125 kHz. A maximum 224 DLC and up to 31 ULC are used so that a total of 255 transmission channels are available. Channels [sic]. Bin “0” which corresponds to 0 Hz cannot be used. If at the same time an analog telephone channel over POTS is used, which takes place with a bandwidth of 300 Hz to 3.4 kHz, bin 1 is used for this purpose and a distance to the data channels is maintained so that only bin 7-21 for ULC, corresponding to 25-138 kHz, and bin 32-255 for DLC, corresponding to 138 kHz to 1140 kHz, are used again. The large frequency spacing ensures noise-free voice transmission and ensures additional transmission of the 16 kHz charging pulse which must be further considered for reason of compatibility.

In Germany the carriers 1 to 32 are reserved for ISDN and POTS (analog). The carriers 33 to 64 are used for ULC, carriers 65 to 255 for DLC. One channel is used for the pilot tone. Moreover DSL modem and DSLAM can ascertain whether they are connected to one another. In the upstream direction accordingly 32 and in the downstream direction 190 channels as shown in FIG. 2 are available.

The channel capacity varies per transmission channel according to the respective channel attenuation and the signal to noise ratio between 0 and 15 bits/Hz. FIG. 2 illustrates the procedure, different signal levels being indicated each time.

This theoretically yields the following data transmission rates for an ideal line:

Assuming ADSL-over-ISDN, defined in Appendix B of standard ITU-T G.992.1, with 4 MHz clock with calculated 190 channels and 15 bits each, at maximum a DLC of 11.4 Mbit/s would be possible. Reed-Solomon coding for error correction reduces the speed however to a maximum 8 Mbit/s, and this under ideal conditions. In the upstream direction for ULC effectively roughly 768 kbit/s are available. The final transmission speed is highly dependent on the line length, the line composition and noise influences and is rarely identical to the maximum possible data rate. In particular the high frequency bands in general cannot be operated with the desired channel efficiency. The network operators define a maximum line length or line quality and accordingly determine which transmission speed they can or would like to offer their customers.

At a carrier distance of 4.3125 kHz the side bands however overlap so that the channel bandwidth is less than 4.3125 kHz. The orthogonality of the COFDM method (coded orthogonal frequency division multiplex) which is used avoids interference here. COFDM characterizes the channel-specific DMT method.

Telephone channels and data channels are conventionally separated by band filters, i.e. also called splitters. Here the low frequency voice channel portions of the POTS channel are routed through a lowpass to a telephone while the high frequency portions are routed through a highpass to the DSL modem, see FIG. 1. In the switching center (Vst. or DIVO) likewise a splitter means divides the analog telephony band from the digital data band and supplies the latter to a multiplexer, the so-called DSLAM (digital subscriber line access multiplexer) which for purposes of the invention constitutes a switching center-side remote station. From there data are conventionally routed via an ATM section (asynchronous transfer mode, called ATM DSLAM) or also alternatively via a gigabit Ethernet (IP DSLAM) to the Internet service provider (ISP) and from there further to the Internet. Alternatively, transmission using the SDH method (synchronous digital hierarchy) is possible. In Europe, upstream and downstream are generally separated from one another by means of echo compensation.

On the subscriber line, interference in the frequency range can occur for various reasons, i.e. channel-individual frequency dependent attenuation of varied type on each individual subscriber line, even for each individual wire pair within an individual cable which is caused for example by different conductor diameters used within a subscriber line, different insulation, by the combined use of cables at the subscriber connection and the resulting reflection, by unfavorable contact-making, by crosstalk of adjacent double wires in the same cable, by leakage, etc. In particular, ISDN and DSL connections in the same cable and DSL connections of adjacent double wires interfere mutually with one another so that transmission problems in general also occur dynamically in time.

For optimization of data transmission in the entire frequency domain, the ADSL modem on the subscriber side and its pendant in the switching center, therefore in pairs at least for each new activation, determine the modulation parameters for the common connection again in order to be able to optimally use the line properties in this way. The DMT data are conventionally computed in the ADSL modem mathematically by means of a fast Fourier transform (FFT). Here the carrier frequency in the frequency spectrum is increased successively and for the respective carrier frequency the corresponding transmission data, especially the signal to noise ratio (SNR), gain and bits per channel, are determined for each individual transmission channel and stored in an internal table. This table is generally re-established each time the modem is turned on again. This initialization process, also called a training phase, is connected in ADSL accordingly with roughly 20 seconds time expenditure.

Whether a channel acts as a DLC or ULC results from the transmission profile within the standardization, via which the modems of a link are initially matched to one another. It is however not possible to change the transmission direction within a channel after this matching, especially dynamically in operation.

In this way, frequency-dependent attenuation values of the transmission link can be largely compensated for example by different assigned gain parameters or frequency ranges in the extreme case can be excluded from use. This takes place for example with the highest frequencies at an increasing distance from the switching center, i.e. at a great line length. The ADSL transmission method is therefore an adaptive transmission method which is individually and automatically optimized for each connection.

For ISDN and ADSL either time division or the frequency division multiplex transmission can be used. The ISDN data stream is inserted into the ADSL data stream in time division multiplex transmission, transmitted over the line, divided by the ADSL modem again into ISDN and ADSL data and made available to the respective terminals. The advantage of this method lies in the elimination of the splitter. The additional transmission of analog telephone signals is possible in this type of transmission. In practice however a highpass or lowpass is recommended for better hardware decoupling.

Since ADSL originated in the US, where primarily analog telephony is operated, the data range can be set comparatively low, starting at for example 20 kHz. In Europe, especially in the Federal Republic of Germany, ISDN is common, by which a higher frequency spectrum for “telephony” is used. In order to keep the upper limit for the two versions and thus the range constant, the European Telecommunication Standards Institute (ETSI) therefore pushed up the lower limit of the ADSL frequency range, maintaining the existing upper limit, by which a smaller downlink bandwidth in systems with frequency division multiplex methods originated. The introduction of the echo compensation method was an aid here. In this connection the small receiver-side useful signal is filtered out of its own high transmitted signal. Thus the uplink and downlink overlap and the downlink bandwidth rises again.

But the high costs for this complex method have an adverse effect. The different channel uses with or without telephony and with Pots or ISDN channel is regulated in the standardization in the corresponding appendices of the standards.

The ADSL in contrast to bit-oriented modem transmissions works in packets. These packets can contain any type of data. Conventionally however they are packets of a higher order network layer such as ATM or Ethernet. Currently there is no unified solution for the protocols to be used for data transport via ADSL. ATM is however partially used on transmission links. The ATM protocol according to the OSI layer model (Open Systems Interconnection) is a layer-2 protocol. Using the physical layer 1 a connection is set up between two points over which data can be then exchanged.

The preferred terminals of ADSL technology are the PC and the set top box for digital TV applications. For this reason USB (Universal Serial Box), PCI (Peripheral Component Interconnect), Ethernet, ATM and UTOPIA (Universal Test and Operations Physical Interface for ATM) interfaces for ADSL technology are favored.

Standard ITU-T G 995.1 outlines the existing DSL standards. Specifications G.992.1, G.992.2, G.991.1, G.991.2, G.996.1, G.994.1 and G.997.1 specify the physical transmission in the DSL method. ITU-T G.994.1, G.996.1 and G.997.1 for this purpose supply expanded information, specify the handshake method in protocol synchronization, interface management, and tests.

Standard ITU-T G.992.1 specifies the physical interface of the ADSL method and the corresponding transport capacity. The customer interface, i.e. the subscriber line-side DSL modem, is called ATU-R (ADSL Transceiver Unit-Remote Terminal End) and the switching center side-interface is called ATU-C (ADSL Transceiver Unit-Central Office End), see FIG. 1. Standard ITU-T G.992.1 specifies a DLC net data rate up to 6.144 Mbit/s, an ULC up to 640 kbit/s with simultaneous operation of an analog telephone or data link (modem operation, fax, etc.), the ISDN alternative follows from standard ITU-T G.961. The actually attainable data rates are largely dependent on the signal to noise ratio (SNR).

In a combination of ITU-T G.992.1 and ITU-T G.994.1, compatibility and handshake procedure on the U interface, i.e. the subscriber line between the switching center and subscriber device, are described so that both transmission devices can communicate with one another. Standard ITU-T G.992.2 specifies the so-called splitterless ADSL method (ADSL lite). Here bandwidth is abandoned in favor of subscriber-side operation without a splitter. Both standards treat “ADSL over POTS” in Appendix A and “ADSL over ISDN” in Appendix B. The latter is more accurately specified in the standard ETSI TS 101 388, where the test criteria in Europe are also established. Standard ITU-T G.992.2 supports the ULC with a maximum 1.536 Mbit/s and DLC up to a maximum 5120 kbit/s.

Standard ITU-T G.991.2 specifies different SHDSL methods on one or more wire pairs, such as for example 784 kbit/s, 1.544 kbit/s (T1) and 2.048 kbit/s (E1). Adaptive line matching does not take place in this procedure. All narrowband channels are equally authorized. The primary application scenario is the basic interface multiplex (primary multiplex) with telephone channels.

Standard ITU-T G.992.3 specifies the ADSL2 method. More recent technology allows better transmission quality and higher transmission rates up to 12 Mbit/s DLC depending on the line quality. Standard ITU-T G.992.4 specifies the splitterless ADSL-2 method. Standard ITU-T G.992.5 specifies ADSL2+, also called ADSL2plus, with an expanded ADSL bandwidth of up to 20 Mbit/s DLC at a line length shorter than 1.5 km and a maximum frequency of up to 2.2 MHz. Furthermore standard ITU-T G 992.4 allows the use of several line pairs at the same time, so called bonding, in order to thus achieve a bandwidth of up to 40 Mbit/s by chaining of line pairs which appear on the application plane as a single high-speed data link. ADSL 2++, which is also called ADSL 4, enables transmission of up to 52 Mbit/s DLC with expanded frequency use of up to 3.75 MHz. The usable line length here in most cases is far below 1000 m, generally below 500 m.

ADSL2 in addition to greater bandwidth also yields advantages such as more efficient modulation, better interference mechanisms and for example a shortened initialization phase.

ADSL2+ is provided with essentially more and more robust transmission methods compared to “old” ADSL methods. If for example temporary interference on the line in ADSL leads to loss of synchronization, it had to be renegotiated afterwards, a time-consuming undertaking. ADSL2+ can dynamically mask noisy carrier frequencies. Under certain circumstances the bandwidth collapses, but the connection is preserved. ADSL2+ has a series of major advantages over predecessor versions.

Thus, for example a current pair function is implemented without loss of synchronization, a reduction of management data during the connection is possible, the bandwidth which has been saved being available to the useful data. A 1-bit modulation on a noisy channel or within a frequency domain and reduction of crosstalk by power control are possible depending on the signal/noise ratio (power cutback) both for DSLAM and also for the ADSL mode. Furthermore, there are additional redundancies in the data stream in order to better be able to recognize faulty data. Thus channels with a poor signal/noise ratio can be used.

In particular the current reduction mechanisms in unused data channels of modem links in continuous operation (always on) are advantageous. They reduce both the power consumption of the devices and also the mutual influence of the connections within the cable.

Modulation methods and channel capacity are preserved in the different methods or are downward-compatible. Higher-speed DSL methods have more bandwidth and accordingly more individual transmission channels, but can also interwork with any remote station of an older specification. In new applications generally ADSL2+ is used. VDSL2 (very high bit rate DSL-2) is a technologically young process and is based on VDSL (standard ITU-T Rec G.993.1). ADSL2plus and VDSL2 are examined in greater detail below. VDSL is extremely complex both in terms of circuitry and functionally; this also appears in the cost situation.

VDSL2 is specified in standard ITU-T Rec. G993.2 and supports asymmetrical and symmetrical communications with a bidirectional net data rate of a total 200 MBit/s at a bandwidth of up to 30 MHz and a maximum 4096 transmission channels. G.993.2 uses DMT modulation and relates essentially to specifications G.993.1 (VDSL), G.992.3 (ADSL2) and G.992.5 (ADSL2plug) and G.994.1 (handshake procedure). ITU-T Rec. G.993.2 defines 16 different transmission bands for downstream and upstream operation which can be alternately used by the operator, i.e. the network operator, and 8 different profiles for this purpose. The profiles vary especially in the manner of use of the lower POTS channels, see FIG. 4. Thus Appendix A of standard G.993.2 relates to North America and takes into account an analog base channel for telephone connections. For the European region, where ISDN is widely used, the specifications according to Appendix B are provided and for Japan those in Appendix C (TCM-ISDN DSL). Other applications work optionally without a telephony channel.

Here, below the 12 MHz limit 5 different bands are specified, which are each in a causal relationship to the reserved telephone bandwidth. If no POTS channel is being transmitted, DS1 begins with 4 kHz, see FIG. 4. The sequence of upload/download bands is also stipulated here, the frequencies according to G.993.2 depending on the destination country are contained in Appendices A, B and C.

The frequency range above 12 MHz depends on the cable parameters in alternative use of the network operator and has not yet been ultimately specified.

In practice the attainable data rate is at roughly 25 Mbit/s and a maximum 1000 m line length and with roughly 12.5 Mbit/s at 1500 m line length, i.e. roughly at the ADSL2+ level. Since in the Federal Republic of Germany there are subscriber lines with up to 8 km line length, the method is suitable preferably in conjunction with the initially described FTTC technology with fiber optic-DSLAM within the subscribe line region, but not for the direct subscriber line to the switching center. FIG. 3 shows for example the transmission bandwidth as a function of the available length of the subscriber line, i.e. the increasing attenuation which occurs with increasing length in signal transmission.

Of course these concomitant phenomena implicitly indicate locally dependent availability and the corresponding disadvantages. It can be assumed that VDSL and VDSL2 are only offered where either very short line lengths are present, or there is enough customer potential on a small area in order to economically finance or maintain expensive fiber optic and DSLAM installation.

For private users, on the German market the product called DSL 1000 with a download data rate of up to 1024 kbits is available. In any case, the upload data rate for this is only up to 128 kbit/s. If the customer would like to use an upload up to 1024 kbit/s, he must resort to the product known as DSL 16000; this requires roughly twice the cost. But this is only possible when he is living in a fiber optic-DSLAM availability region; this is currently still of low probability. With it he then acquires up to 16 Mbit/s download capacity which he possibly does not need when it may be required only in a higher ULC. Upload rates which are higher than 1024 kbit/s are however not available to him with DSL 16000. Products with a higher transmission rate are currently not offered to private users.

In any case a fixed bandwidth is not guaranteed to the customer, but only so-called “bandwidth corridor”. The maximum attainable speed with which the VDSL2 modem in the residence of the line holder synchronizes with the corresponding modem in (outdoor) DSLAM is ultimately dependent among others on the selected transmission service, on the state of the copper subscriber line and on the distance to the (outdoor) DSLAM. In this way even when using a DSL 16000 method often only a much lower data transmission rate than the maximum possible 16 MBit/s is available.

In the business customer sector, the prospect for the customer on the German market still looks commercially more unfavorable. While the business customer can win with a product called “Business 1000” with 1024 kbit/s download data rate and up to 128 kbit/s upload data rate, for a higher upload demand of for example 1024 kbit/s only one product “Business 1000 symmetrical” is available to him at five times the price compared to the asymmetrical pendant, in any case only up to a total data volume of a maximum 20 GByte. The user therefore has much higher costs because he requires the same bandwidth as for “Business 1000”, in any case in the opposite direction.

It can be at least recognized in these numbers that the increase of the upload speed for private and business customers with unclear availability of the products in the respective line region is associated with much higher costs than those of a download data rate with comparable capacity.

A connection is set up between the ADSL modem and remote station, i.e. DSLAM, in ADSL2+ for example according to the procedure outlined below:

Synchronization of the two devices takes place using synchronization channels or pilot tones. The ADSL subscriber modem and DSLAM during the synchronization phase first agree on a transmission method since it must be observed that different hardware versions can be connected according to a different standard and then verify the available carrier frequencies without telephone channels. Subsequently the number of bits which can be encoded per channel is tested depending on the transmission features of the line connection. This testing can be repeated in operation which is underway for ADSL2+ without the connection having to be cut back, as was the case for ADSL. The respectively determined parameters are exchanged between the participating modems and stored for later operation.

FIG. 5 schematically shows the use of the available bandwidth in the frequency domain in ADSL2 and ADSL2+ for different telephone channels with the corresponding reference to standardization according to ITU-G.992.3/5 Appendix A, M and B. In the lower region especially for “ADSL over ISDN” the available data channels are shown. In FIG. 5 T stands for a telephone channel, ULC for the uplink channel and DLC for the downlink channel.

In ADSL2 as shown in FIG. 5 the frequency spectrum from 0 Hz to 1104 kHz which is used for transmission of telecommunications data are divided into 256 transmission channels, and the first transmission channel however corresponding to 0 Hz and cannot be [sic]. Of them however not all transmission channels are available for upload/download data transmission from and to the Internet. According to standard G.992.3/5 Appendix B which specifies ADSL over ISDN, the frequency range which is intended for upload begins for example only at 138 kHz; this corresponds to transmission channel 33. The lower transmission channels are reserved for telephony and data transfer via ISDN. As shown in FIG. 5, transmission channels 33 to 64 are consequently used as upload channels ULC and channels 65 to 255 as download channels DLC. Data are thus transmitted by means of ADSL2 within a frequency range of a total bandwidth of 1104 kHz, which frequency range is subdivided into 256 transmission channels, a first group of transmission channels, specifically channels 33 to 64, being assigned to upload data transmission and a second group of transmission channels, specifically channels 65 to 255, being assigned to download data transmission. The first group comprises 32, the second group 190 transmission channels, as the sum of transmission channels of the two groups a total number of 222 transmission channels being available for data transmission. In ADSL2+ the second group is expanded by another 256 transmission channels so that a total of 478 transmission channels are available for data transmission. The frequency spectrum in ADSL2+ has a total bandwidth of 2208 kHz and is divided into 512 transmission channels.

FIG. 6 schematically shows the structure of an ADSL modem with Ethernet router and WLAN wireless station, as corresponds to the prior art for ATU-R installation. A powerful processor (CPU) has a program storage (PrS), a data storage (DaS) and parameter storage (PaS). The PaS is used here for storage of parameterization data and configuration data of the hardware circuit, the connected interfaces and the ADSL link. The CPU uses peripheral components such as interrupt control, timer and interface lines (I/O) as well as clock supply (not shown). ATM-SAR (Asynchronous Transfer Mode—Segment and Reassembly Controller) is necessary in ATM transmission which is often used and forms the ATM remote station to the ATM network of the network operator. Since the ATM has fixed channel structures, in modem ADSL methods several ATM links are transmitted in parallel at the same time. ADSL transmitters and receivers make available the actual ADSL link and complete the ATM-SAR. Other interfaces enable connection of conventional PC and data technology. Here especially Ethernet interfaces should be cited, protocol conversion from ATM to Ethernet taking place preferably by the processor and the data flowing over the system bus, their being buffered for processing of the different protocols and frame structures in the DaS. In current technology in general there are usually several Ethernet interfaces and one router so that several PCs can be connected to the device without additional network hardware. This is especially advantageous in the domestic domain. USB interfaces are often used for configuration of the device by means of PC, but especially for direct connection of a printer used in the network or a common backup hard disk (network attached-storage, NAS). WLAN as a wireless interface preferably to a notebook and/or to a cableless device connection complete the functionality.

FIG. 7 schematically shows the transmitter reference model, for ATM/STM transport (Asynchronous Transfer Mode, Synchronous Transfer Mode) according to standard ITU-T G.992 for both ATU-C, see FIG. 7A, and also ATU-R, see FIG. 7B, and the corresponding additions/modifications of the transmitter ATU-C as claimed in the invention, see FIG. 7C, and ATU-R, see FIG. 7D.

The corresponding receivers can be built to be compatible with the respective technical configuration of the transmitters. The procedure as claimed in the invention is first explained in combination with ADSL standard G. 992.1. The particulars of higher quality ADSL methods are detailed separately below.

FIG. 7A shows the typical ATU-C transmitter. The ATM signals of the ATM-SAR are combined in a multiplex module (MSC) for the corresponding frame structure of the DSL transmission technology. The greater the transmission bandwidth, the more ATM connections can be incorporated. CRC (cyclic redundancy control) and SC (scrambling) are used for data and channel encoding and for assembly of the DSL frame structure together with synchronization constructs. In channel control (TO, tone ordering) the assignment of the transmitter-side transmission channels takes place, i.e. the individual bits. In the case of G. 992.1/3 (ADSL over ISDN) they are the ADSL2-DLC channels z=1.190 and for G 992.5 ADSL2plus-DLC channels z=1.446 in the corresponding frequency range, see FIG. 5.

The module E/G in FIG. 7 (constellation encoder and gain scaling) assigns the corresponding individual transmission parameters to the respective transmission channels, i.e. the number of transmitted bits and level values which are converted in the inverse discrete Fourier transform (IDFT) from the frequency domain into the time domain and are made available in twice the number as time-continuous signals. The DACP (digital/analog converter) converts the parallel signals into a time-continuous serial data stream, buffers them for transmission and converts the digital signals into analog signals which are injected into the subscriber line in the final transmission means, see FIG. 6.

FIG. 7B shows the ATU-C transmitter in a schematic. The number of ATM sources is comparatively smaller according to the lower data rate of the ULC so that the multiplex device can be made simpler. In TO only the ULC z=1.32 are assigned; this is reflected in the E/G in the parameter set for 32 channels which is reduced accordingly relative to the ATU-R. The inverse Fourier transform requires less computing power and the shift register can be designed to be shorter for example.

The procedure is described for the download for example in standard ITU-T G.992.1, Chapter 7.7 and for upload in Chapter 8.7. Here the transmission parameters for the channels within the training phase of the initialization procedure are computed in the receiver and transmitted to the transmitter.

The parameters are stored with reference to the pertinent frequency in both modems in a table in the PaS. The initialization procedure is described with specification of parameter exchange for example in Chapter 10 of ITU-T G.992.1.

ADSL2plus according to ITU-T G.992.3 is in comparison more complex, since this method makes available more channels and other technical possibilities. The corresponding transmitter compared to FIG. 7 differs not in the schematics of functional blocks, but especially in the number of configurable transmission parameters of the different blocks. Thus, for example here due to the dynamically adaptable bandwidth the multiplex device MSC and parallel/serial converter can also be configured. Furthermore the so-called latency path function can be configured which especially within the DSL frame structure is responsible for especially time-critical transmissions and within FIG. 7 is summarized with the scrambling function (SC) as less relevant detail.

In current technology almost all components of the ADSL modem, see FIG. 6, are integrated with the additional interface functions within a single integrated circuit or less integratable circuits. Here as many ADSL functions as possible which are described above as individual functional blocks are assembled within a program-controlled high-speed signal processor. The software solution enables on the one hand for the manufacturers the limitation to as few components as possible with a large number of items and thus acceleration of the development process, on the other hand this solution enables early market entry at a time at which the standards have not yet been finally accepted and the products are functionally incomplete, in any case however inadequately tested and still faulty. Later, corrections and expansions are downloaded from the Internet into the modules by software download.

This possibility is likewise relevant to the method as claimed in the invention and enables updating of existing modems with the additions or modifications as claimed in the invention.

ADSL2plus specification ITU-T G.992.3 in Chapter 10 under dynamic behavior among others calls for on-line reconfiguration (OLR). This operating mode enables dynamic reconfiguration, i.e. matching of different transmission parameters, in operation which is underway. The background of the procedure is especially the high demand for electrical power dissipation (especially DSLAM) which is substantiated by the high transmission power and enormous required computing power of the digital signal processors for numerous transmission channels, i.e. by the bandwidth, and the mutual influence of high frequency transmission methods in the same cable, these problems increasing with further customer acceptance, i.e. with the number of transmission links in the same cable. The procedure enables reduction of the transmission capacity of a given profile in operation underway when less data need to be or are to be transmitted and along with this reduction of the power consumption and interference without activating time-consuming resynchronization again if necessary. The procedure of course provides for increasing dynamic interference profiles in the same cable, for which reason dynamic adaptation of transmission properties is especially important.

OLR methods include especially bit swapping (BS) which enables establishment of the number of coded bits with the respective amplification parameters depending on the dynamic line properties of the specific transmission frequency, dynamic rate repartitioning (DRR) which is designed to change the frame structure or multiplex properties in ADSL transmission, by which especially different latency times in data transmission which are necessary for different applications arise, for example for voice transmission with high transit time requirements, and seamless rate adaption (SRA). SRA is designed for modification of the data rate by reduction of transmission channels. Modulation methods, channel number and frame structure/multiplex methods are varied for implementation. In addition, within the channels which are no longer being used synchronization is sent; this was not possible in ADSL according to ITU-T G.992.1, the synchronization enabling commissioning of channels later if necessary.

In order to make available high data rates in VDSL2 according to G.993.2 over a range of up to 350 m, the VDSL2 spectrum was expanded from 12 to 30 MHz, the transmission power increased to 20 dBm, and echo suppression techniques used. Of course interference increases. High performance chip sets can operate up to 48 full rate VDSL2 ports in DSLAM as a 2 chip version. At this packing density in any case flexible framing and online reconfiguring such as STRA, DRR are essential. At this degree of complexity and the manifold possibility of interference, it can thus be expected that the usable data rate in many applications is much smaller than the theoretical maximum limit, which are specified by network operators. The most recent research focuses on mutual interference of the VDSL2 transmissions in the same cable which with an increasing number of customers likewise increase and try to reduce mutual interference by for example coupled strategies within the cable.

In ADSL2 oscillation behavior in the bandwidths could be generated by mutual interference when several transmission links are adjusted up and down automatically in a mutual effect.

Different strategies for reducing power consumption, especially in DSLAM, and for noise prevention, especially adaptation of the data rate by SRA and new standby and sleep modes, are known. Using an adaptive bandwidth with bandwidth reduction for mutual interference of adjacent ADSL connections in the same cable is known. The possibility of blocking the lower frequency band below 1.1 MHz is aimed in the same direction. This measure prevents especially the noise action of the high ADSL2 levels on adjacent ADSL connections of the older type with the CAP standard and vice versa, which are still ubiquitous in North America.

ADSL2 by different logic and/or physical transmission channels enables service optimization. Thus for example the CVoDSL (Channelized Voice over DSL) option offers the use of separate transmission channels for voice. This is due to the different transit time conditions for IP packets since the IP method is fundamentally poorly suited for voice transmission. Digital voice transmission requires time-continuous transmission of sampling values for avoiding failures, and echo.

The raising of the transmission levels, the decreasing range, the necessary replacement of copper by fiber optic links, increased mutual interference, standby and sleep methods, as well as the OLY methods BS, DRR and SRA, frequency range blocking and other measures represent the added cost for technology which arises by the higher demands for transmission bandwidth and physical limits. The choice of a higher value ADSL technology as a solution for the demand for a higher upload data rate is therefore not always the best solution technically and economically.

It has been described that in the available ADSL transmission methods, aside from a few available and expensive VDSL2 methods, there is no possibility for making available higher upload data rates. Since in many ADSL technologies it is optional for the network operator to alternatively use several transmission profiles, theoretically a modem can be used for different applications. In any case the disadvantage is that no profiles are standardized for higher ULC with the total bandwidth of an available technology remaining the same so that the user must buy a higher upload data rate with a likewise higher download data rate which however is optionally not used, to the extent it is technically available at all in the subscriber line area. Dynamic channel reduction SRA is known, but is used for transmission adaption to different dynamic noise criteria. Dynamic profile switching in operation underway, where DLCs become ULCs and vice versa, is conversely not disclosed.

This invention makes available an increased upload data rate without increasing the respective total bandwidth of any DSL technology, especially for ADSL links such as ADSL, ADSL2, ADSL 2plus, and VDSL, without in doing so undertaking the necessary change of the respective technical transmission methods, such as the type of modulation, source encoding and code reduction. This is achieved in that the transmission channels defined within an ADSL standard of for example 4 kbit/s or 4.3125 kbit/s etc. can be used individually, alternatively in groups or in turn alternatively according to the frequency or channel bands defined from time to time within the standards alternatively as a download (DLC) or upload channel (ULC) and thus higher ULC with simultaneous reduction of the DLC can be made available by the corresponding configuration of the two communicating modems.

Alternative switching between the methods takes place preferably dynamically in operation which is underway. For this purpose at least the transmitter and receiver of the DSL modems and the segment and reassembly controller, the multiplexer and if necessary the hardware interfaces and media access controller can be modified according to the corresponding bandwidths such that the respective maximum transmission bandwidths can be handled and the corresponding parameter storages are designed for simultaneously accommodating the complete transmission parameters and modem configuration parameters for both DLC and also ULC traffic together, the corresponding parameter sets being chosen by the operating mode agreed upon between the modems.

FIGS. 5, 7 and 8 illustrate the procedure. Compared to existing procedures of permanently assigned transmission channels of ULC and DLC, as is shown schematically in FIG. 5, the modified method as claimed in the invention as shown in FIG. 8 has universally usable channels in both data directions, here characterized as UUDC (universal upload/download channel) which can be alternatively used completely or alternatively partially or also individually for one direction or the other.

Complete use of all channels in one preferred direction at a time is preferably not of interest since the DSL protocol traffic also requires acknowledgements, etc. in the opposite direction. If necessary one traffic direction can however be reduced to a minimum as much as possible optionally in favor of the bandwidth in the reverse direction.

One especially preferred embodiment and moreover an easily understandable version of this procedure enable reversed, inverse use of the existing transmission channels. While for example in ADSL over ISDN according to standard ITU-T G 992.1, G 992.3 and with expanded bandwidth according to ITU-T G.992.5 according to Appendix B (FIG. 7B) has an uplink data rate of ULC=32 channels (z=32 with 138 kbit/s) and a downlink data rate DLC according to FIG. 7A of a maximum 190+256 (z=446 channels with 1.9 Mbit/s), according to FIG. 7D with reversed use a maximum 1.9 Mbit/s ULC and according to FIG. 7C 136 kbit/s DLC are possible.

This procedure can be understood especially easily and implemented for different DSL methods and is called DRP-ADSL (Dynamic Reserve Profile ADSL) below.

Fundamentally, in use on ADSL2+ a total of 2.38 Mbit/s total transmission rate with any subdivision can be implemented, and optionally also different dynamic or static profiles can be implemented for example for heavy download traffic, for heavy upload traffic and for symmetrical traffic, for example for video or voice uses.

If the alternative transmission profile(s) is/are stored within the communicating modems, a single control sequence for switching between the methods is sufficient. The choice and initiation of the transmission profiles can be caused alternatively by the network operator or customer, and the network operator in hardware/software implementations can stipulate certain restrictions of the usable profiles and/or switching possibilities. On the subscriber side alternatively manual profile switching, i.e. switching caused by the user, or automatic switching for example by the operating software of the modem or by application software, are recommended, and in the latter case for example automatically depending on the forthcoming application, i.e. download, upload, voice application, etc., it can be decided case-specifically by for example depending on the current online operating behavior and connected service, automatic evaluation of real time behavior and/or data load in both traffic directions is carried out and based on given priorities and/or method rules one of the given transmission profiles is automatically selected. This procedure can become permanent, temporary, one-time in connection of hardware or when loading new software or when changing communications behavior, for example when new programs or drivers are loaded.

Since neither the channel number nor coding methods etc. of the existing DSL methods are altered with the procedure as claimed in the invention, the technological cost remains comparable. In a complete hardware implementation the required components for handling of additional transport possibilities as shown in FIG. 7 must be completely implemented. In addition, ATM SAR is expanded if necessary since at this point both in ULC as well as in DLC the maximum bandwidth must be maintained although it is used only alternatively either or. DSL modems which are preferably made with high speed digital signal processors DSP, and have program control, conversely without additional hardware means can be expanded as claimed in the invention since all the computing power is oriented to the total bandwidth and not to the transmission direction. These modems can be equipped with the corresponding modified control, and in addition more storage for configuration and parameter storage PaS must be available. Many devices are equipped from the factory with redundant storage for security, others can be retrofitted in the field in socketed memory modules.

One in turn alternative embodiment of implementation omits expanded PaS and after switching of transmission methods executes one reinitialization at a time with the training phase. In particular for ADSL2plus and modems with limited parameter storage PaS this procedure can be of interest since here especially extensive parameter lists are necessary, the circuit is preferably designed in DSP technology with program control (standard before delivery still incomplete) and reinitialization can be done in a few seconds (fast startup). In this way especially the private customer could profit with cost-neutral introduction of the ADSL transmission methods into his existing model and could get over the omission of dynamic switching.

If permanently high symmetrical data rates are required, optionally at least two ADSL links can be operated with one ADSL modem at a time in parallel in combination on a multipath router, see FIG. 9, at least one of the ADSL links being operated in the DRP-ADSL mode. In this procedure, for a DSL 1000 product 1.152 Mbit/s, for DSL 2000 2.240 Mbit/s, for DSL 6000 6.592 Mbit/s and for DSl 16000 17.1024 Mbit/s are available bidirectionally. In a cost comparison, savings are considerable in this way. If both modems are operated in DRP-ADSL mode, the following data rates at maximum are alternatively available: 2×DSL 1000 with ULC/DLC=2048 kBit/s, 2×DSL 2000 with ULC/DLC=4098 kBit/s, 2×DSL 6000 with ULC/DLC=12032 kBit/s, and 2×DSL 16000 with ULC/DLC=32000 kBit/s.

For purposes of this invention therefore a DSL method with variable upload/download bit rate and application-specific dynamic profile switching, abbreviated VUDB-DSL, is proposed; it modifies future and existing DSL methods, such as for example ADSL, ADSL2, ADSL 2plus, VDSL, etc. while maintaining the respective total bandwidth and the specific modulation and coding methods as claimed in the invention such that the transmission channels and frequency ranges which are unidirectional from time to time according to conventional standardization and which are intended for either upload traffic ULC or download traffic DLC, now as claimed in the invention partially or preferably all can be dynamically switched as universal ULC/DLC data channels (UUDC universal upload download channels), i.e. frequency ranges, alternatively as individual transmission channels or transmission frequencies, channel groups or frequency groups or in complete channel bands or frequency bands preferably in current traffic for upload or download traffic, see FIG. 8. Within the models the functional prerequisites must be present for the data transmission rates which are maximum at the time in both directions. This alternatively can be implemented as a hardware implementation or alternatively by means of a high speed digital signal processor and the corresponding program control or alternatively mixed.

The functional expansions exist especially in a modified segment and reassembly controller for ATM/SDH interfaces, compare FIG. 6, and especially in expanded modem components of the transmitter and receiver. Modification relates on the transmitter side at least to functional units IDFT and OPSB, and the parameter assignment of bits and B&G and especially expanded storage possibilities which are necessary for the transmission parameters and configuration parameters which are likewise more extensive at this point according to the more complex channel use, and which for example can assume twice the scope when the channels are all made universally usable in both directions.

In the DSL method with universal upload/download channels and application-specific dynamic profile switching, furthermore the initialization phase of the modems relative to the conventional procedure can be optionally expanded such that all channels which are alternatively used as DLC or ULC are measured in both transmission directions within a corresponding training phase and the corresponding transmission parameters, especially the channel-specific attenuation, modulation and amplification parameters are stored for later use in PaS, by which delay-free switching between the corresponding transmission profiles in current operation is enabled.

In the DSL method as claimed in the invention, switching between the transmission profiles on the network side (network operator) or alternatively on the subscriber side (customer) can take place manually or alternatively automatically, one preferred embodiment calling for automatically initiated subscriber-side profile switching for example by the operating software or application software. Profile switching depends on the forthcoming communications tasks. Automatic evaluation of real time behavior and/or data incidence in both traffic directions is carried out, and based on given priorities and/or method rules an accordingly optimized ULC/DLC channel division is chosen automatically. This procedure can be activated or can be in operation permanently, temporarily, one-time in connection of hardware or when loading new software or alternatively in dynamic alteration of the communications behavior of the subscriber, for example when new programs or drivers are loaded, or download application, upload application or voice application, etc. are forthcoming.

Moreover there can be limitation of channel division possibilities to useful fixed profiles, whose switching can take place with a short command sequence between the participating modems. It is technologically simple to exchange the upload and download frequency bands while maintaining the POTS channels; this can be called dynamic reverse profile ADSL. This procedure has the conventional DLC-intensive ADSL transmission profile (high download profile HDP) and the ULC-intensive profile which is reversed as claimed in the invention (high upload profile HUP) between which it is possibly to easily and dynamically switch back and forth and which optionally can be supplemented by a symmetrical profile for audio and video telephony, peer-to-peer computer coupling, etc., for example (symmetrical profile SP).

Keeping the complete transmission and configuration parameters within the modem for both transmission directions can be optionally omitted if in this way for example cost or retrofitting advantages arise, the corresponding parameters in this procedure for each profile or channel switched being re-determined each time by a test of the link properties, or alternatively being loaded from an external onto a subscriber-side or network-side storage means.

It is especially advantageous in the proposed method that dynamic bandwidth division in both traffic directions can be optionally used within network nodes and switching facilities at any location of the transmission and switching network of the network operation, between the network operators, and of the Internet backbone in order to be able to dynamically react to different traffic behavior, i.e. to match the transmission paths adaptively to the different traffic load without the need for expensive overcapacities for at least one of the traffic directions.

Furthermore, one special advantage of the invention is that for implementation of high upload traffic or high symmetrical traffic it enables use of several, but at least two DSL modems with DSL links connected to at least one multipath router with load division, see FIG. 9, at least one of the ADSL links being operated in the VUDB-ADSL method as claimed in the invention or in the DRP-ADSL method.

In summary, this invention, especially in ADSL connections which have separate upload and download channels or frequency bands in DMT technology, calls for formation of universal upload/download channels UUDC (Universal Upload Download Channel) which can be used optionally in each traffic direction. The choice and switching of the channels and traffic direction take place dynamically in current operation preferably automatically, depending on the forthcoming application and the corresponding traffic demand, i.e. Internet download, mail upload, voice applications, videoconference, IP-TV, etc. One especially advantageous version can be called DLC-ADSL (Dynamic Reverse Profile ADSL). It consists of the transmission profiles HDP (High Download Profile), i.e. a transmission profile which corresponds to the normal ADSL method with high-speed download and slow upload, and the reversed, inverse profile HUP (High Upload Profile), i.e. a transmission profile with high-speed upload and slow download, switching being possible between the transmission profiles with a simple sequence of commands. One useful addition is a symmetrical profile (SP) for audio telephony and videotelephony or peer-to-peer computer coupling, for example.

Transmission links can be better utilized and overcapacities prevented by the method as claimed in the invention, since traffic peaks in one direction are routed over free transmission channels of the direction which is the other one at the time, and at this point are used bidirectionally for these purposes in their transmission direction.

### ABBREVIATIONS IN THE FIGURES

MSC multiplexer, synchronization, control
CRC cyclic redundancy control
SC scrambling/interleaving
TO channel control
E/G encoder and amplifier
IDFT inverse discrete Fourier transform
OPSB output parallel/serial converter and buffer
DACP digital/analog converters and analog processing
A,B,C,Zi reference points according to ITU.T G.992.1
Bits* channel assignment expanded
B&G* transmission parameters expanded
ATM asynchronous transfer mode
SAR segment and reassembly controller
MAC media access controller
PHY physical interface
PrS program storage
DaS data storage
PaS parameter storage
USB universal serial bus

1. A method for adaptation of upload and download data transmission rates of a DSL link within, between and/or subsequent to telecommunications or data networks, especially between a subscriber-side modem and the remote station of a switching center, wherein data transmission taking place within a frequency range of a certain total bandwidth, the frequency range being divided into transmission channels, and a first group of transmission channels which are arranged consecutively or randomly being assigned to upload data transmission and another group of transmission channels which are arranged consecutively or randomly being assigned to download data transmission and the sum of the transmission channels of the two groups corresponding to the total number of transmission channels which are available for data transmission, characterized in that the number of transmission channels of the two groups is changed depending on the individually required upload and/or download data transmission rate while maintaining the total bandwidth.

2. A method as claimed in claim 1, wherein the upload data transmission rate of the first group is increased by adding transmission channels from the second group so that at the same time the download data transmission rate drops since its channel number is reduced to the same extent.

3. A method as claimed in claim 1, wherein adaptation takes place by exchanging the numbers of transmission channels of the two groups or by inverting the respective transport direction.

4. A method as claimed in claim 1, wherein adaptation to obtain a symmetrical data transmission rate takes place by assigning the same numbers of transmission channels to the two groups.

5. A method as claimed in claim 1, wherein adaptation to obtain a symmetrical data transmission rate takes place by assigning the respectively required numbers of transmission channels to the two groups, the number of transmission channels used for each group being set into a relation to the individual transmission capacity of the individual transmission channels and the total transmission capacity of the respective transmission direction being the same.

6. A method as claimed in claim 1, wherein the number, arrangement and use of the transmission channels of preferred traffic variants is defined in at least one transmission profile, adaptation of the upload and download data transmission rates taking place by switching from a first transmission profile to another transmission profile.

7. A method as claimed in claim 6, wherein predefined transmission profiles are stored in the modems and switching takes place by exchange of a control sequence.

8. A method as claimed in claim 6, wherein based on given priorities and/or method rules one of the transmission profiles is chosen.

9. A method as claimed in claim 1, wherein adaptation of the upload data transmission rate takes place dynamically in current operation.

10. A method as claimed in claim 1, wherein adaptation of the upload data transmission rate takes place automatically on the subscriber side by the operating software of the modem or the application software of the user, especially by its operating system, application software, or driver of its computer or data terminal, or on the network side by the network operator.

11. A method as claimed in claim 1, wherein the real time behavior and/or data load of the data transmission in both traffic directions is evaluated and the upload data transmission rate is adapted depending on this evaluation.

12. A method as claimed in claim 11, wherein the real time behavior and/or data load of the data transmission is evaluated permanently or temporarily.

13. A method as claimed in claim 1, wherein the upload data transmission rate is adapted when an application software, of a use of the application software and/or a driver is started and/or ended.

14. A method as claimed in claim 1, wherein within an initialization phase of the modem the bidirectionally usable transmission channels are each measured in both transmission directions and the transmission parameters which have been determined accordingly are stored in at least one modem.

15. A method as claimed in claim 14, wherein as transmission parameters the channel-specific attenuation, modulation and/or amplification parameters are measured.

16. A method as claimed in claim 1, wherein automatic bandwidth adaptation of the transmission channels depending on the traffic load in both traffic directions, especially within telecommunications networks, for example between network nodes, is used so that existing broadband bottlenecks in existing physical transmission media of limited total bandwidth, especially in cable or wireless connections, can be equalized, and/or a savings effect in infrastructure can be achieved compared to conventional procedures, wherein transmission links in both directions are laid out according to the maximum possible traffic load of the respective direction, this occurs especially in data links but unfortunately generally unidirectionally.
